(19) United States
(12) Patent Application Publication
(10) Pub. No.: US 2025/0326011 A1
(43) Pub. Date: Oct. 23, 2025

(54) DRAIN CLEANERS WITH A TOP-MOUNTED LIGHT ASSEMBLY

(71) Applicant: Emerson Professional Tool, LLC, Elyria, OH (US)

(72) Inventors: Madelyn Bauer, Cleveland, OH (US); Billy Odon M. Yrad, JR., Amherst, OH (US); Alexander Emerson Meyer, Lakewood, OH (US)

(21) Appl. No.: 18/642,139

(22) Filed: Apr. 22, 2024

(51) Int. Cl. B08B 9/045; B08B 9/047

(52) U.S. Cl. CPC B08B 9/045; B08B 9/047; B08B 2209/04

(57) ABSTRACT

A drain cleaner includes a housing and a rotatable drum disposed in the housing. The rotatable drum has a rotational axis about which the drum rotates. A drain cleaning cable is at least partially disposed in the rotatable drum. A light assembly is disposed in the housing. The light assembly is disposed above the rotational axis of the rotatable drum.

### FIELD

The field of the disclosure relates generally to drain cleaners and, more particularly, to handheld drain cleaners.

### BACKGROUND

Handheld drain cleaners include a flexible cable disposed within a rotatable drum. The drum is typically driven by an electric motor. Some drain cleaners are driven by a drill which removably engages the drum. Rotation of the drum causes the drain cleaning cable to rotate. An operator may activate a forward or reverse actuator to translate rotation of the cable to axial movement of the cable to advance or retrieve the drain cleaning cable from the drain cleaner during drain cleaning operations. While advancing the drain cleaning cable from the drain cleaner, the drain cleaning cable is withdrawn from the drum and travels through a nose assembly that is forward of the drum. The drain cleaning cable passes through an outlet of the nose assembly and into the drain. The drain cleaning cable may be retracted back into the drain cleaner and the drum after the drain cleaning operation is complete.

Some conventional drain cleaners include a light assembly disposed below the nose of the drain cleaner to illuminate the nose and drain. The light assembly is aligned with the power supply and drain cleaner printed circuit board(s) which are disposed in the lower portion of the drain cleaner which minimizes light assembly wiring.

A need exists for drain cleaners that better illuminate the drain cleaner nose assembly, work area, and drain inlet and for drain cleaners that can accommodate relatively longer lengths of light assembly wiring.

This section is intended to introduce the reader to various aspects of art that may be related to various aspects of the disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### SUMMARY

One aspect of the present disclosure is directed to a drain cleaner. The drain cleaner includes a housing and a rotatable drum disposed in the housing. The rotatable drum has a rotational axis about which the drum rotates. A drain cleaning cable is at least partially disposed in the rotatable drum. A light assembly is disposed in the housing. The light assembly is disposed above the rotational axis of the rotatable drum.

Yet another aspect of the present disclosure is directed to a drain cleaner. The drain cleaner includes a housing. At least a portion of the housing includes an inner wall and an outer wall. A rotatable drum is disposed in the housing. The rotatable drum has a rotational axis about which the drum rotates. A drain cleaning cable is at least partially disposed in the rotatable drum. A light assembly is disposed in the housing. The drain cleaner includes a power wiring assembly for powering the light assembly. The power wiring assembly is at least partially disposed between the inner wall and outer wall of the housing.

Various refinements exist of the features noted in relation to the above-mentioned aspects of the present disclosure. Further features may also be incorporated in the above-mentioned aspects of the present disclosure as well. These refinements and additional features may exist individually or in any combination. For instance, various features discussed below in relation to any of the illustrated embodiments of the present disclosure may be incorporated into any of the above-described aspects of the present disclosure, alone or in any combination.

### BRIEF DESCRIPTION OF THE DRAWINGS

FIG. 1 is a perspective view of a drain cleaner;

FIG. 2 is another perspective view of the drain cleaner;

FIG. 3 is a perspective view of the drain cleaner showing the nose assembly;

FIG. 4 is perspective view of the drain cleaner showing the drive assembly and drum;

FIG. 5 is perspective view of the drain cleaner showing the battery compartment;

FIG. 6 is a side view of the nose assembly of the drain cleaner;

FIG. 7 is a perspective view of the guide tube of the nose assembly;

FIG. 8 is a perspective view of the grip of the nose assembly;

FIG. 9 is a perspective view of the drain cleaner showing the guide tube;

FIG. 10 is another perspective view of the guide tube;

FIG. 11 is a perspective view of the drain cleaner showing the drum;

FIG. 12 is a perspective view of the drum;

FIG. 13 is an exploded view of the drive assembly and drum;

FIG. 14 is a perspective view of the nose assembly and forward housing segment of the drain cleaner;

FIG. 15 is a detailed cross-section side view of the nose assembly of the drain cleaner;

FIG. 16 is a perspective view of a light assembly of the drain cleaner;

FIG. 17 is a perspective view of the light assembly and housing of the drain cleaner;

FIG. 18 is another perspective view of the drain clear showing the light assembly;

FIG. 19 is a cross-section view of the drain cleaner showing a channel for the wiring assembly that powers the light assembly;

FIG. 20 is another cross-section view of the drain cleaner showing the channel; and

FIG. 21 is a side view of the drain cleaner showing a control module.

Corresponding reference characters indicate corresponding parts throughout the drawings.

### DETAILED DESCRIPTION

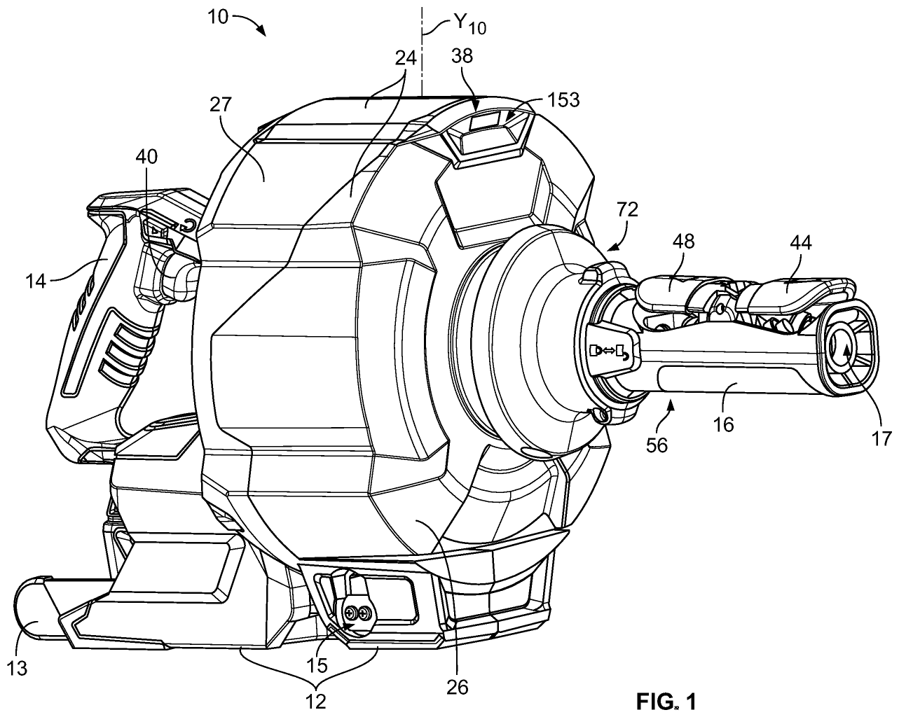

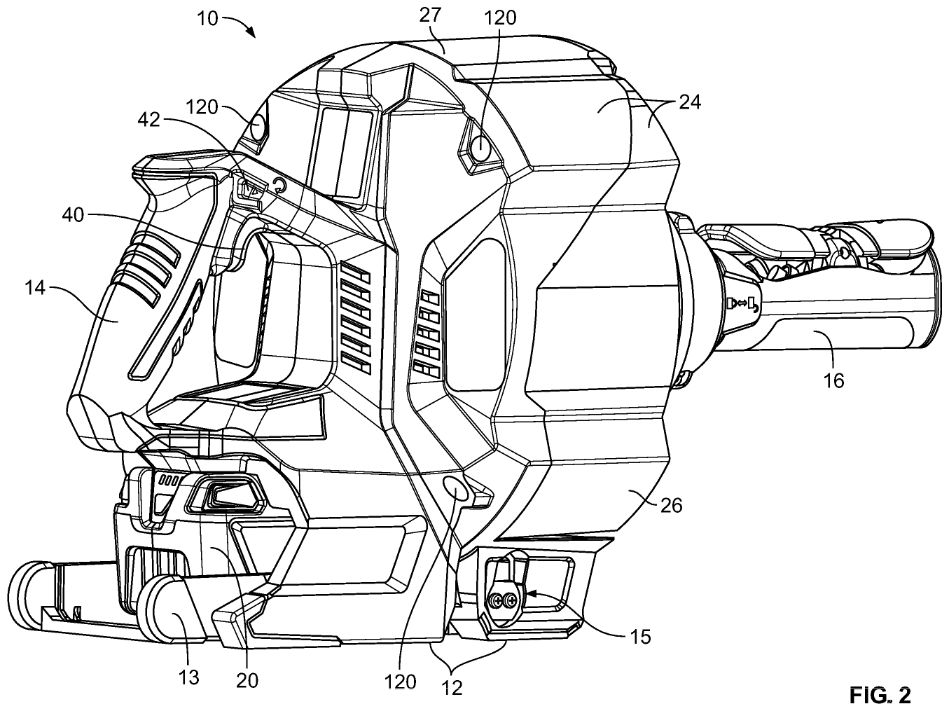

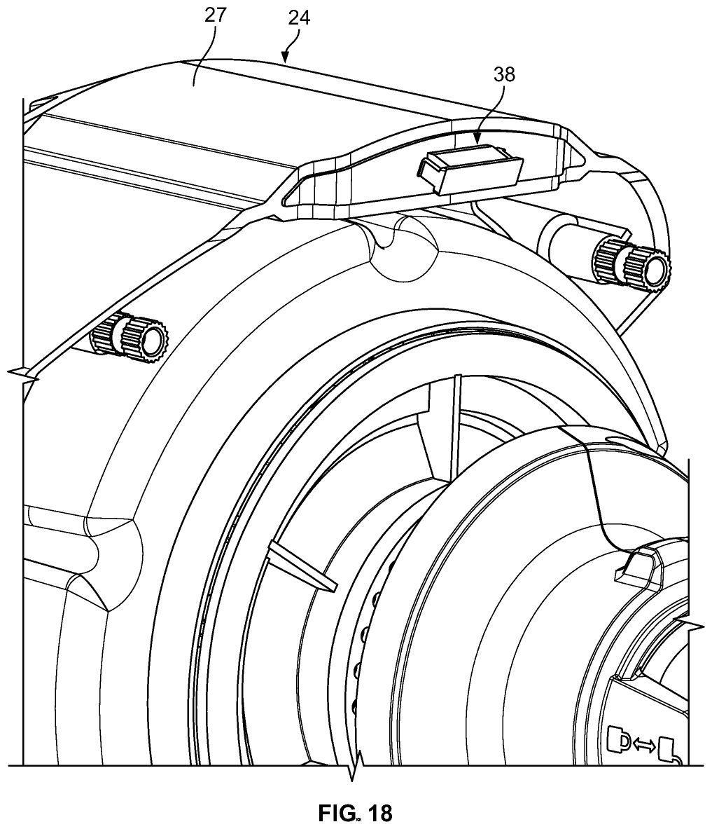

An embodiment of a drain cleaner 10 is shown in FIGS. 1-21. The illustrated drain cleaner 10 is configured to be handheld and includes a handle 14 and a grip 16 for manipulating the drain cleaner 10. The drain cleaner 10 is powered by a rechargeable battery 20 (FIG. 2). In other embodiments, the drain cleaner 10 includes a cord or may include both a battery 20 and a cord to power the drain cleaner.

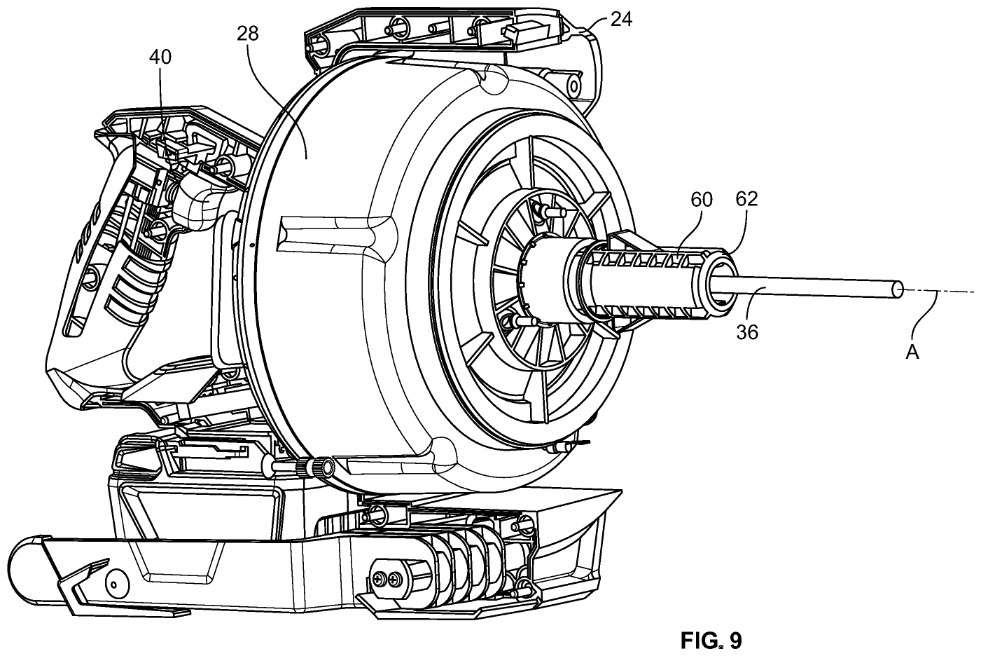

The drain cleaner 10 operates by rotating a cleaning head (not shown) of a drain cleaning cable 36 (FIG. 9) as the cleaning head moves through a drain. The drain cleaning cable 36 rotates as the cable 36 is advanced (and retracted) through a drain. The drain cleaner 10 includes a light assembly 38 (FIG. 1) to illuminate the drain cleaning cable 36 and the drain opening.

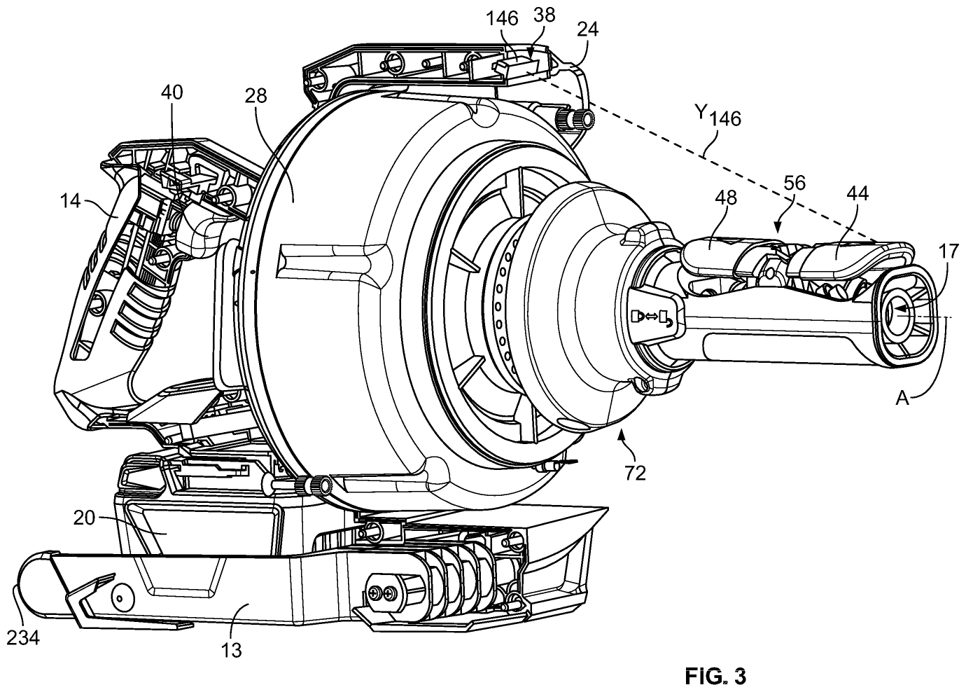

The drain cleaner 10 includes a housing 24. A rotatable drum 28 (FIG. 3) is disposed in the housing 24 and rotates relative to the housing 24. The drain cleaner housing 24 includes a forward housing segment 26 (FIG. 1) and a rear housing segment 27. The forward housing segment 26 is removably connected to the rear housing segment 27. The rear housing segment 27 includes the handle 14.

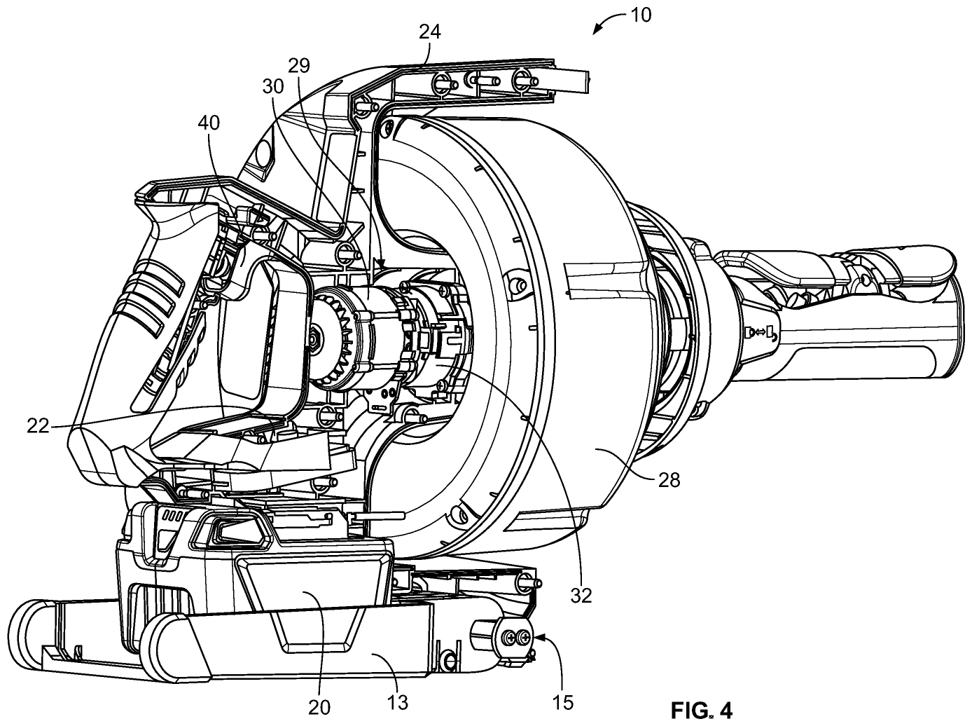

A drive assembly 29 (FIG. 4) that includes a motor 30 and gear box 32 is disposed in the housing 24. In other embodiments, the motor 30 and/or gear box 32 are disposed exterior to the housing 24. In yet other embodiments, the drain cleaner 10 does not include a motor and is powered by a motor separate from the drain cleaner 10 (e.g., a drill).

During drain cleaning operations, the drain cleaner 10 may rest on its base 12 (i.e., the lower surfaces of the drain cleaner housing 24) or may rest on a support stand 13. The support stand 13 is pivotally connected to the housing 24 at a pivot joint 15. An operator of the drain cleaner 10 may pivot the support stand 13 such that the support stand is below the housing 24. When the support stand 13 is pivoted downward, the support stand 13 may contact the supporting surface (e.g., sink, floor or bathtub) and the support stand 13 supports the weight of the drain cleaner 10.

The drain cleaning cable 36 (FIG. 9) is at least partially disposed in the drum 28. When powered, the drive assembly 29 causes the drum 28 to rotate about an axis A (FIG. 3). Rotation of the drum 28 causes the drain cleaning cable 36 to also rotate. The drive assembly 29 is powered upon actuation of a switch 40 (shown as a trigger) that is disposed in the handle 14. The switch 40 is biased to the off position such that the switch 40 must be continuously actuated by a user to power the drive assembly 29. The switch 40 variably changes the speed at which the drain cleaning cable rotates based on the degree of actuation of the switch 40.

The drain cleaning cable 36 may be advanced (i.e., extracted from the drain cleaner 10) by manipulating a cable feed forward actuator 44 for extracting the drain cleaning cable from the drain cleaner 10. A cable feed retraction actuator 48 may be manipulated to retract the cleaning cable back into the drain cleaner 10. The forward actuator 44 and retraction actuator 48 translate rotation of the drain cleaning cable 36 into axial movement of the drain cleaning cable 36 (i.e., advancement and retraction of the cable 36). The cable feed forward actuator 44 advances the drain cleaning cable and the cable feed retraction actuator 48 retracts the drain cleaning cable for a given direction of rotation of the drum 28 (e.g., clockwise when viewed from the back). If the forward-reverse switch 42 (FIG. 2) is moved to a reverse status (causing the drum 28 to rotate in the opposite direction), the cable feed forward actuator 44 retracts the drain cleaning cable and the cable feed retraction actuator 48 advances the drain cleaning cable.

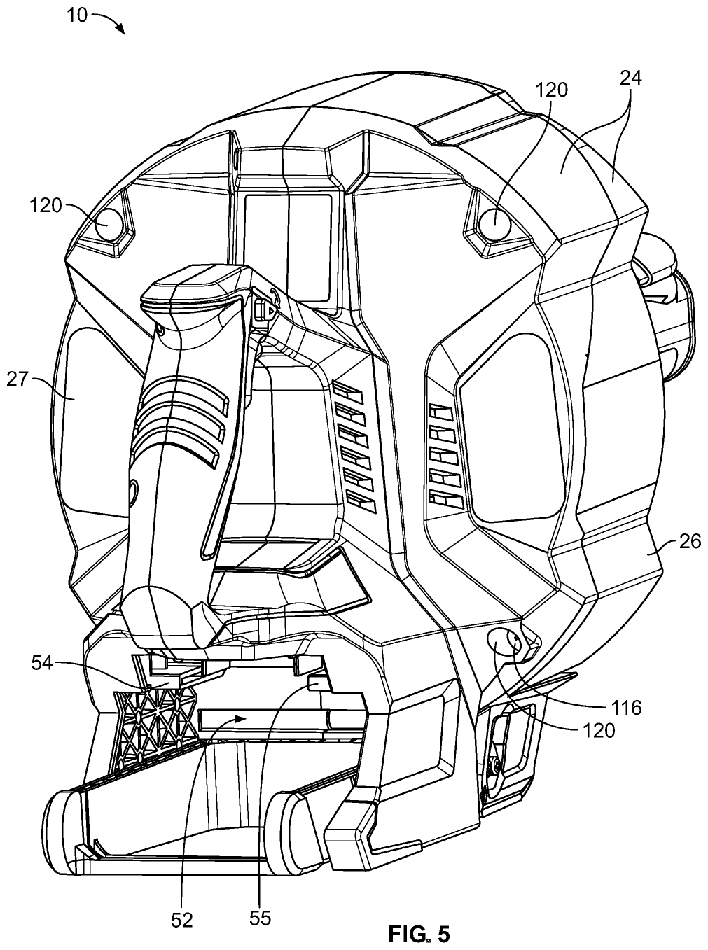

The battery 20 (FIG. 2) is disposed within a battery compartment 52 (FIG. 5). The battery 20 is supported by first and second rails 54, 55. The battery 20 is removable and rechargeable and, in the illustrated embodiment, is an 18 volt battery.

The drain cleaner 10 includes a control module 22 (FIG. 4) having a controller (e.g., printed circuit board assembly which includes a controller). The battery 20 supplies power to the control module 22. The control module 22 is configured to supply DC power to the motor 30 upon actuation of the switch 40.

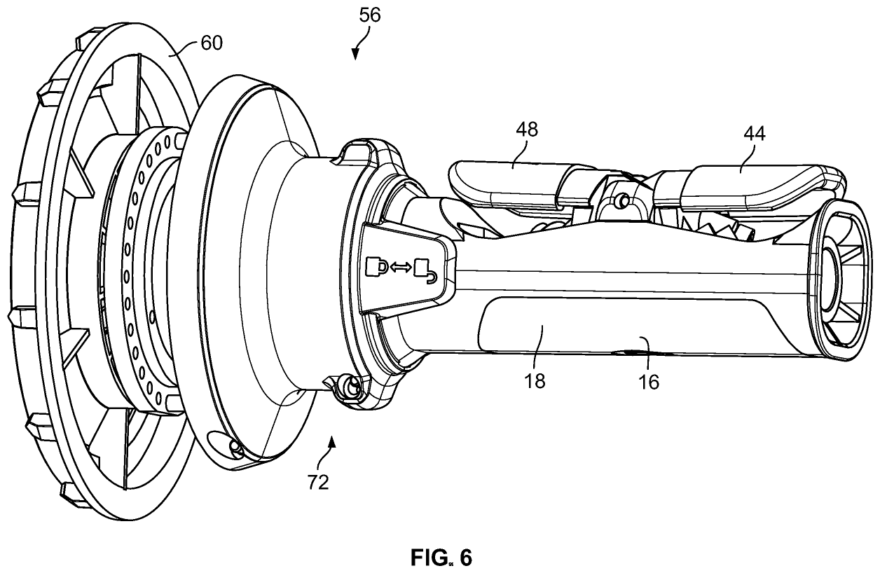

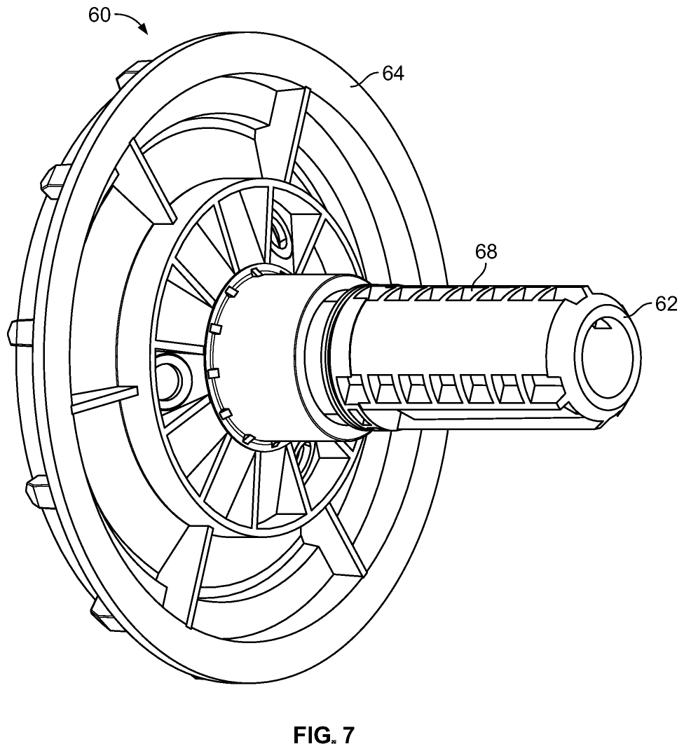

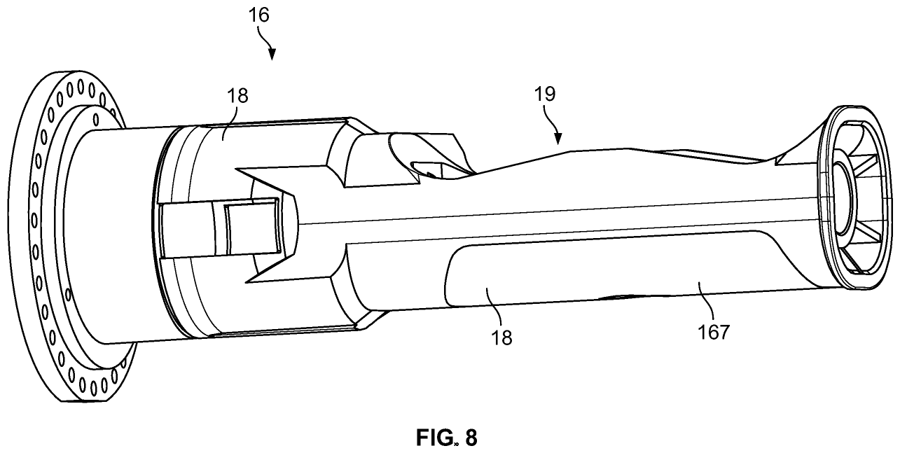

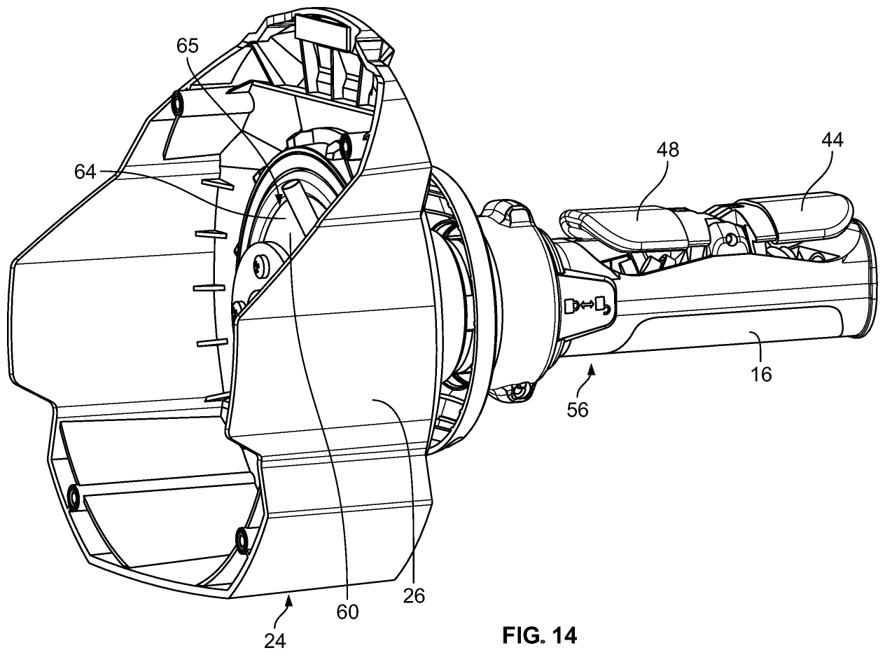

The drain cleaner 10 includes a nose assembly 56 which is forward of the drum 28 relative to the rotational axis A (FIG. 3). Referring now to FIG. 6, the nose assembly 56 includes the grip 16 and includes a guide tube 60 that rotates with the drum 28 (FIG. 3). The grip 16 extends from the forward housing segment 26 and is not axially slidable relative to the housing 24. The grip 16 includes grip surfaces 18. The guide tube 60 (FIG. 7) includes a tubular portion 68 and a flange 64 that extends radially outward from the tubular portion 68. The guide tube 60 is at least partially disposed in the grip 16 (i.e., a portion of the tubular portion 68 is disposed within the grip 16). The grip 16 has a chamber 19 (FIG. 8) in which the forward actuator 44 and retraction actuator 48 (FIG. 1) are disposed. The nose assembly 56 (FIG. 6) also includes a cable lock assembly 72 that axially locks the drain cleaning cable 36 (FIG. 9). The nose assembly 56 extends through an opening 65 (FIG. 14) of the housing 24.

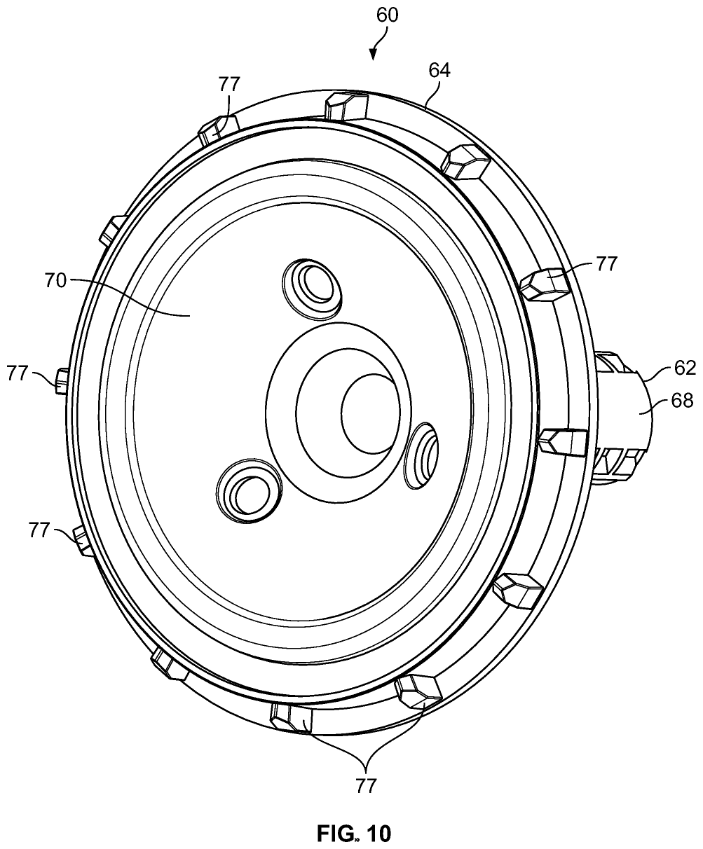

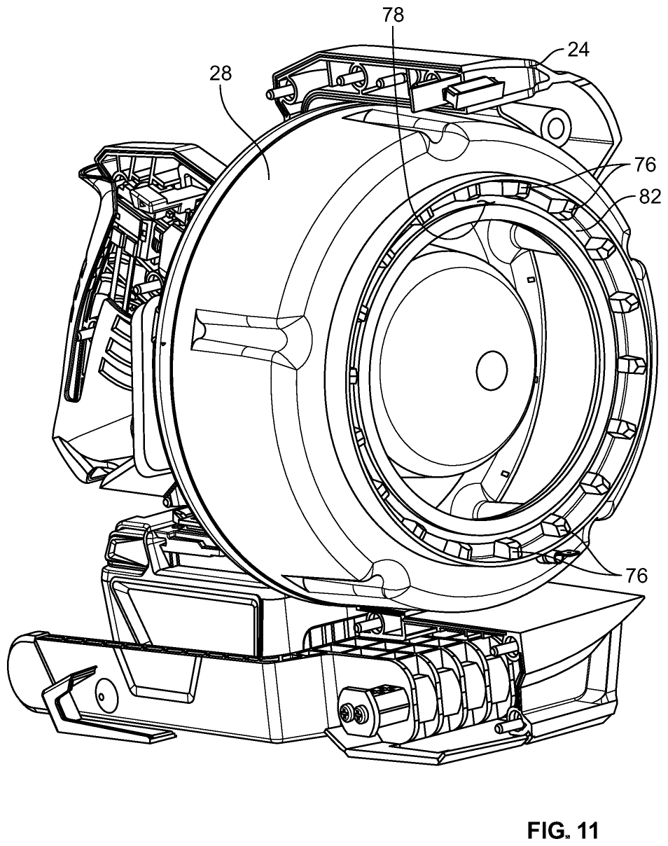

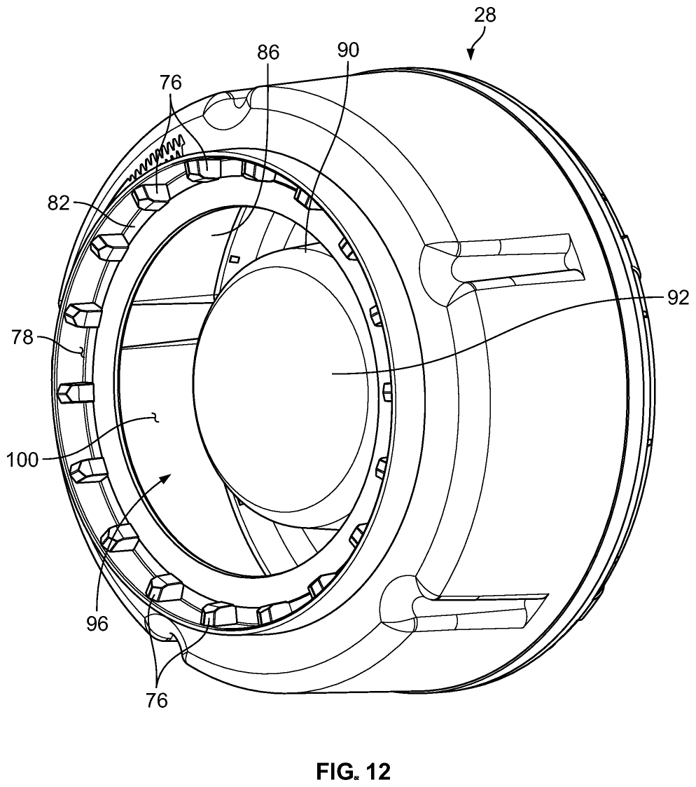

The drum 28 includes a set of first teeth 76 (FIG. 11) that engage a set of second teeth 77 of the guide tube 60 (FIG. 10) during rotation of the drum 28 and guide tube 60. The drum 28 includes a recess 78 (FIG. 12) in which the first teeth 76 are disposed. The teeth 76 extend from a shoulder 82 that defines the recess 78.

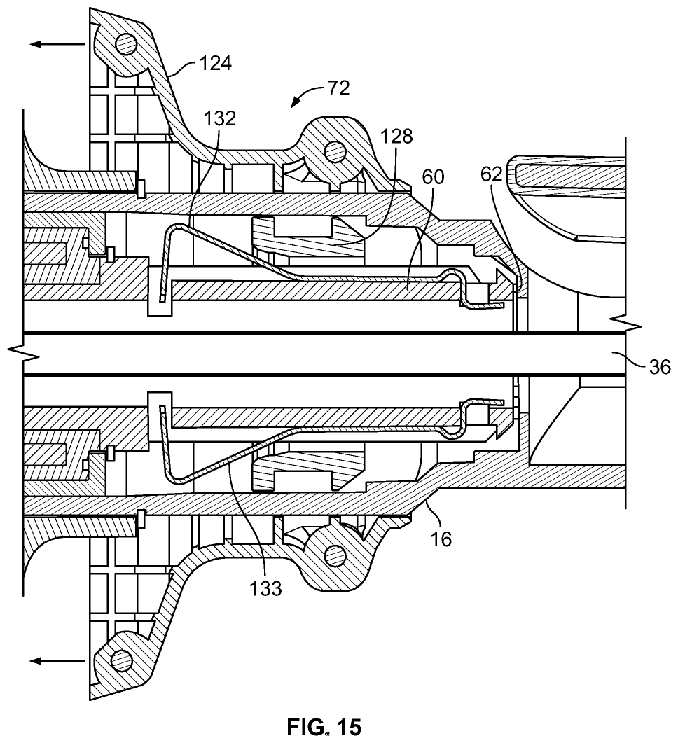

The drain cleaning cable 36 (FIG. 9) is at least partially disposed in the drum 28. Referring now to FIG. 12, a drum channel 96 extends between an outer wall 86 and an inner wall 90 disposed within the drum 28. The inner wall 90 is the circumferential edge of a drum protuberance 92 that extends into the drum 28. The drain cleaning cable 36 (FIG. 15) is partially disposed in the drum channel 96 in one or more windings of the drain cleaning cable. The drain cleaning cable 36 (FIG. 15) extends from the drum 28 through a drum opening 100 (FIG. 12) and into the guide tube 60 (FIG. 9). The guide tube flange 64 (FIG. 10) includes a frustoconical surface 70 that is sized and shaped to direct the drain cleaning cable toward the tubular portion 68. The drain cleaning cable 36 exits the guide tube 60 at the forward end 62 (FIG. 15) of the guide tube 60 and continues through the grip 16 and passes through a drain cleaner outlet 17 (FIG. 1).

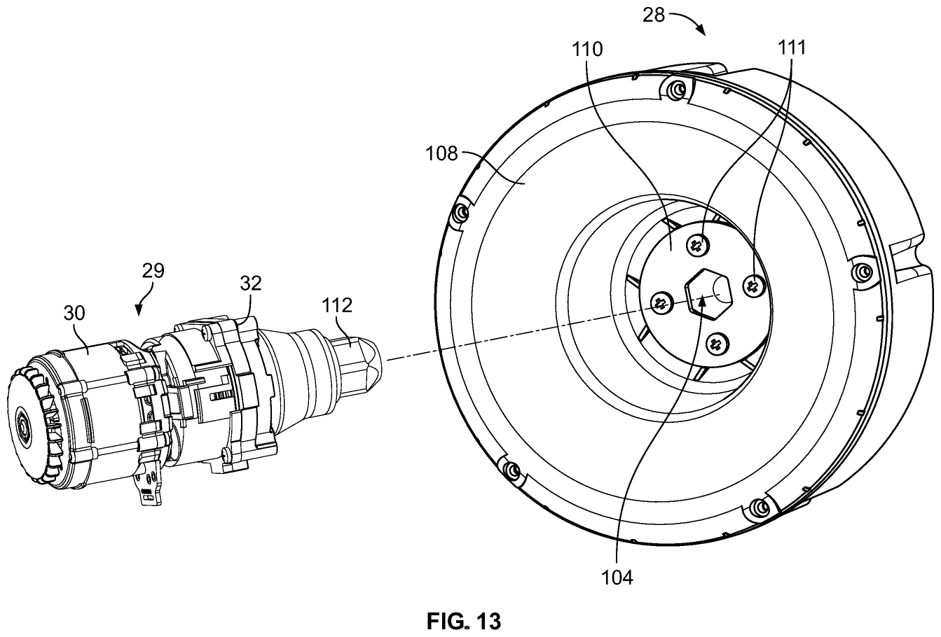

Referring now to FIG. 13, the drum 28 includes a drum aperture 104 for receiving a shaft 112 of the drive assembly 29. The drum 28 includes a main body 108 and a plate 110 (e.g., metal plate) that is connected to the main body 108 by fasteners 111. The metal plate 110 forms the drum aperture 104. The drum aperture 104 is sized and shaped to receive the shaft 112 such that rotation of the shaft 112 causes the drum 28 to rotate. In the illustrated embodiment, the shaft 112 and drum aperture 104 are both hex-shaped.

The drain cleaner 10 includes one or more fasteners 116 (one fastener being shown in FIG. 5) that removably connect the rear housing segment 27 to the forward housing segment 26. In the illustrated embodiment, the fasteners 116 are threaded fasteners. Each fastener 116 is disposed within a housing notch 120 to allow the fasteners 116 to be recessed within the rear housing segment 26.

As shown in FIG. 14, the guide tube 60 extends through the forward housing segment 26. To access the drum 28 (e.g., to interchange the drum), the fasteners 116 are removed and the forward housing segment 26 and the nose assembly 56 are separated from the drain cleaner. The drum 28 (FIG. 13) is axially slidable along the shaft 112 of the drive assembly 29 which allows the drum 28 to be separated from the drain cleaner 10.

Referring now to FIG. 15, the cable lock assembly 72 includes a cable lock sleeve 124. The grip 16 and guide tube 60 are disposed within the cable lock sleeve 124. The sleeve 124 is axially slidable relative to the grip 16 and the guide tube 60. The sleeve 124 engages a collar 128 that is disposed between the guide tube 60 and the grip 16. To lock the drain cleaning cable 36, the sleeve 124 is moved axially in the direction of the arrows which causes the collar 128 to move. The collar 128 contacts locking members 132, 133 (e.g., leaf springs) and causes the locking members 132, 133 to apply a clamping force to the drain cleaning cable 36. When the sleeve 124 is moved to the locked position, the collar 128 rotates with the guide tube 60 and the drain cleaning cable 36. The collar 128 rotates independent from the sleeve 124 and grip 16 enabling the sleeve 124 and grip 16 to remain in place as the collar 128 rotates.

The drain cleaner 10 includes a light assembly 38 (FIG. 1) that illuminates the drain cleaning cable 36 and the drain being cleaned. As shown in FIG. 3, the light assembly 38 is disposed above the rotational axis A of the drum 28.

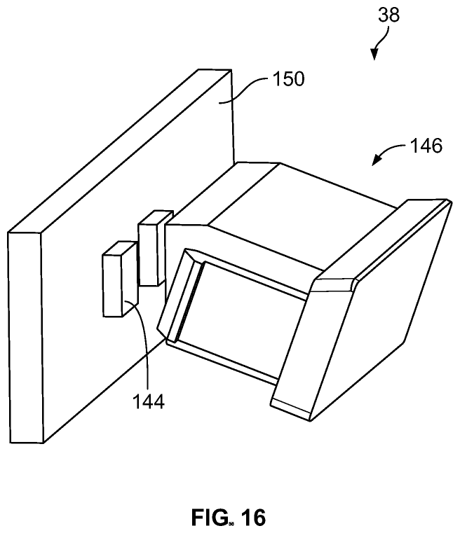

Referring now to FIG. 16, the light assembly 38 includes a light source 144, a light pipe 146 and a light assembly circuit board 150. In the illustrated embodiment, the light source 144 is connected to the circuit board 150. The light source 144 may be any suitable light such as one or more light-emitting diodes (e.g., two LEDs as in the illustrated embodiment). As shown in FIG. 3, the light pipe 146 has a light pipe axis Y₁₄₆ and the light assembly 38 directs light along the light pipe axis Y₁₄₆. The light pipe axis Y₁₄₆ is angled relative to the rotational axis A of the drum 28 such that light is directed toward the rotational axis A (FIG. 3). In this arrangement, the nose assembly 56 and the drain cleaning cable 36 (FIG. 9) that extends from the drain cleaner outlet 17 (FIG. 3) are illuminated during drain cleaning operations. As light exits the light pipe 146, light fans out along the light pipe axis Y₁₄₆ such that the illumination radius increases as the distance from the light assembly 38 increases which causes the work area and drain inlet to be illuminated.

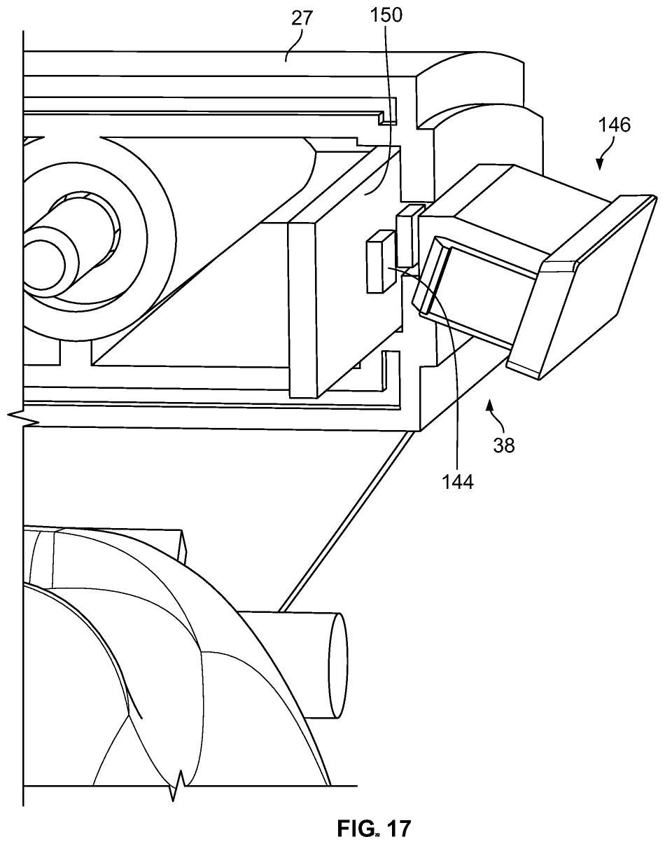

The light assembly 38 is disposed in the drain cleaner housing 24 (FIG. 1). The light pipe 146 is aligned with a housing aperture 153 to enable light to pass through the housing 24. AS shown in FIG. 17, the light source 144 and light assembly circuit board 150 are disposed in the rear housing segment 27. The circuit board 150 is connected to the rear housing segment 27 (e.g., disposed within a slot formed in the housing 24). The light pipe 146 is at least partially disposed in the forward housing segment 26 (FIG. 1). The light pipe 146 is separable from the circuit board 150 and light source 144. Upon separation of the forward housing segment 26 and nose assembly 56 from the rear housing segment 27 (i.e., upon loosening of fasteners 116), the light pipe 146 separates from the light source 144 and circuit board 150 which remain connected to the rear housing segment 27.

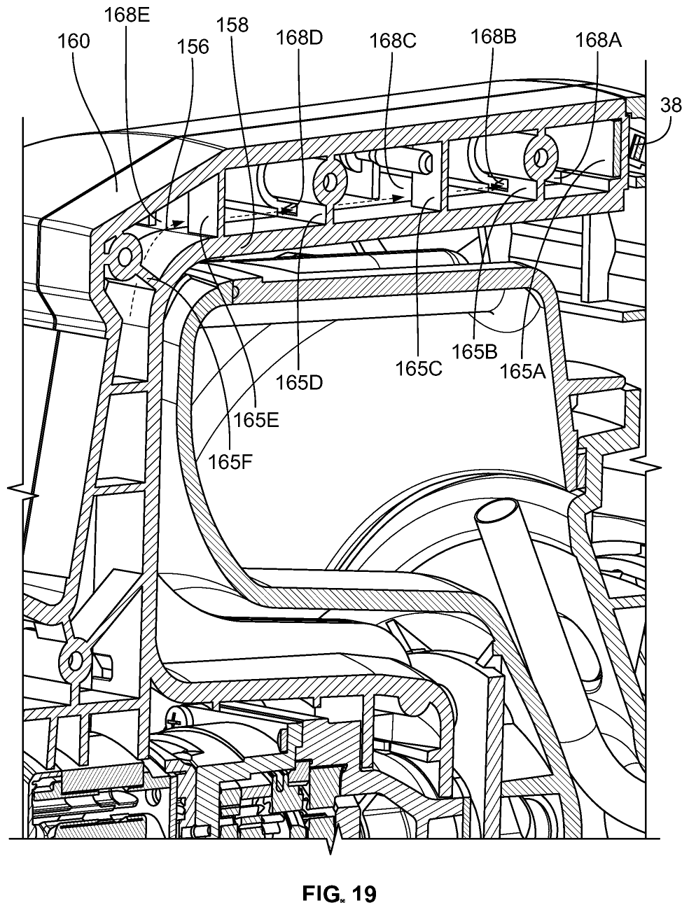

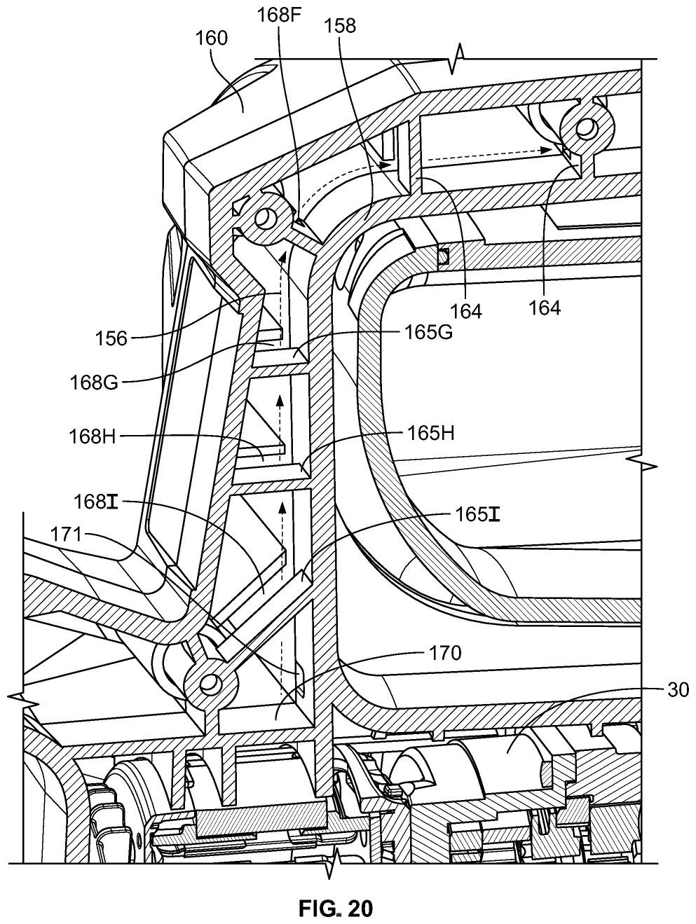

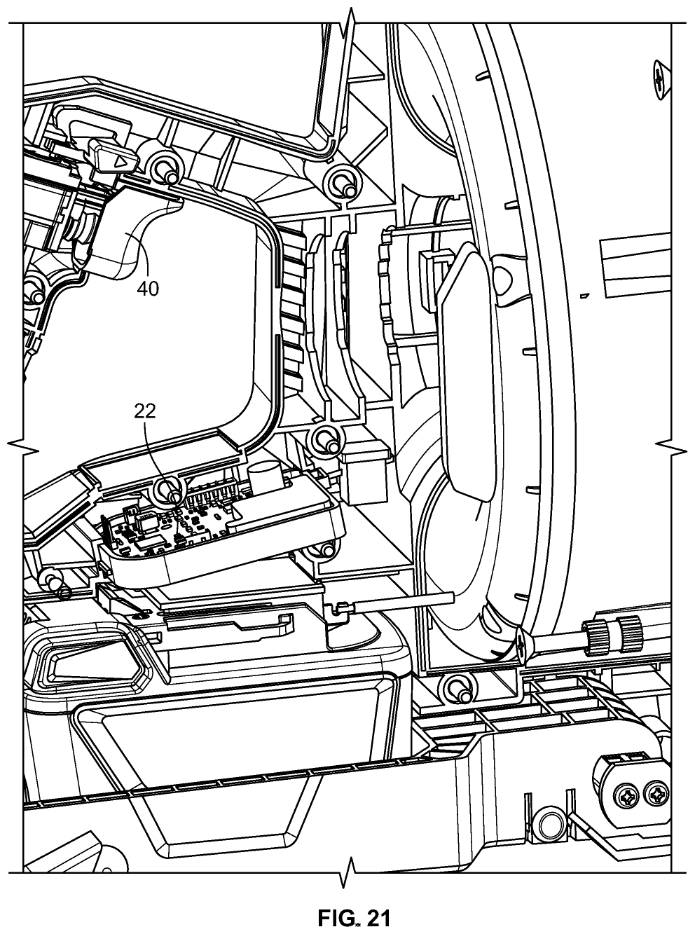

A power wiring assembly (not shown) extends from the control module 22 (FIG. 21) to the light assembly 38 (FIG. 19). The wiring assembly is disposed within a wire channel 156 (FIGS. 19-20) that at least partially extends between the control module 22 (FIG. 22) and the light assembly (FIG. 21). The channel 156 is disposed between an inner wall 158 and an outer wall 160 of the housing 24. The housing 24 includes a plurality of support ribs 165 (first through ninth support ribs 165A-I being shown in FIGS. 19-20) that each include a recess 168A-I formed therein through which the power wiring assembly extends. The housing 24 may include additional support ribs through which the power wiring assembly does not pass (e.g., rib 170 shown in FIG. 20). From ninth recess 168I (FIG. 20), the power wiring assembly travels through a wall recess 171, around the motor 30. and to the control module 22 (FIG. 21).

The drain cleaner 10 is configured to power the light assembly 38 during drain cleaning operations. For example, the drain cleaner 10 may be configured to power the light assembly 38 during the periods in which the switch 40 (FIG. 21) is actuated. In such embodiments, actuation of the switch 40 causes both the drive assembly 29 and light assembly 38 to be powered.

In some embodiments, the drain cleaner 10 is configured to power the light assembly 38 for a time period after the switch ceases to be actuated by the operator (i.e., after release of the switch 40). For example, the light assembly 38 may be powered for at least 4 seconds, at least 8 seconds, or for 10 seconds or more after the switch 40 is released. Delayed deactivation of the light assembly 38 may be achieved by use of a delay timer incorporated in the drain cleaner controller.

Compared to conventional drain cleaners, drain cleaners of the present disclosure have several advantages. By use of light assembly that is disposed above the rotational axis, the nose assembly and drain are better illuminated. The path of light may avoid an operator's hand supporting the grip. Better illumination is especially advantageous in the cramped, dark environments in which the drain cleaner may be used. A channel that extends through the housing to the light assembly enables the light assembly to be powered from the control module without reducing the integrity of the housing.

As used herein, the terms “about,” “substantially,” “essentially” and “approximately” when used in conjunction with ranges of dimensions, concentrations, temperatures or other physical or chemical properties or characteristics is meant to cover variations that may exist in the upper and/or lower limits of the ranges of the properties or characteristics, including, for example, variations resulting from rounding, measurement methodology or other statistical variation.

When introducing elements of the present disclosure or the embodiment(s) thereof, the articles “a”, “an”, “the” and “said” are intended to mean that there are one or more of the elements. The terms “comprising,” “including,” “containing” and “having” are intended to be inclusive and mean that there may be additional elements other than the listed elements. The use of terms indicating a particular orientation (e.g., “top”, “bottom”, “side”, etc.) is for convenience of description and does not require any particular orientation of the item described.

As various changes could be made in the above constructions and methods without departing from the scope of the disclosure, it is intended that all matter contained in the above description and shown in the accompanying drawing[s] shall be interpreted as illustrative and not in a limiting sense.

What is claimed is:

1. A drain cleaner comprising:
a housing;
a rotatable drum disposed in the housing, the rotatable drum having a rotational axis about which the drum rotates;
a drain cleaning cable at least partially disposed in the rotatable drum; and
a light assembly disposed in the housing, the light assembly being disposed above the rotational axis of the rotatable drum.

2. The drain cleaner as set forth in claim 1 comprising a rechargeable battery.

3. The drain cleaner as set forth in claim 2 comprising a control module and power wiring assembly that extends from the control module to the light assembly, the power wiring assembly being disposed within a channel that at least partially extends between the control module and the light assembly.

4. The drain cleaner as set forth in claim 3 wherein at least a portion of the housing comprises an inner wall and an outer wall, the channel being disposed between the inner wall and the outer wall.

5. The drain cleaner as set forth in claim 4 comprising a plurality of support ribs that extend between the inner wall and the outer wall, each support rib having a recess formed therein through which the power cable extends.

6. The drain cleaner as set forth in claim 1 wherein the light assembly is configured to direct light toward the rotational axis.

7. The drain cleaner as set forth in claim 6 wherein the light assembly comprises:
a light source; and
a light pipe that directs light from the light source toward the rotation axis.

8. The drain cleaner as set forth in claim 7 wherein the light pipe has a light pipe axis, the light pipe axis being angled relative to the rotational axis.

9. The drain cleaner as set forth in claim 1 wherein the housing has a forward housing segment and a rear housing segment, the forward housing segment being removably connected to the rear housing segment.

10. The drain cleaner as set forth in claim 8 wherein the light assembly comprises:
a light source disposed in the rear housing segment; and
a light pipe that directs light from the light source toward the rotation axis, the light pipe being at least partially disposed in the forward housing segment.

11. The drain cleaner as set forth in claim 10 wherein light pipe is removable from the light source.

12. The drain cleaner as set forth in claim 11 comprising a nose assembly, the nose assembly being removably connected to the rotatable drum, the nose assembly comprising:
a grip; and
a guide tube that is rotatable with the drum.

13. The drain cleaner as set forth in claim 12 wherein the guide tube is at least partially disposed in the grip.

14. The drain cleaner as set forth in claim 1 comprising:
a drive assembly for rotating the drum, the drive assembly comprising a motor disposed in the housing; and
a switch that powers the drive assembly upon actuation of the switch by an operator, the drain cleaner being configured to power the light assembly during actuation of the switch.

15. The drain cleaner as set forth in claim 14 wherein the drain cleaner is configured to power the light assembly for a time period after the switch ceases to be actuated by the operator.

16. A drain cleaner comprising:
a housing, wherein at least a portion of the housing comprises an inner wall and an outer wall;
a rotatable drum disposed in the housing, the rotatable drum having a rotational axis about which the drum rotates;
a drain cleaning cable at least partially disposed in the rotatable drum;
a light assembly disposed in the housing; and
a power wiring assembly for powering the light assembly, the power wiring assembly being at least partially disposed between the inner wall and outer wall of the housing.

17. The drain cleaner as set forth in claim 16 comprising a rechargeable battery.

18. The drain cleaner as set forth in claim 16 comprising a plurality of support ribs that extend between the inner wall and the outer wall, each rib having a recess formed therein through which the power cable extends.

19. The drain cleaner as set forth in claim 16 comprising a nose that extends from the housing, the drain cleaning cable extending through the nose, the light assembly being configured to direct light toward the nose.

20. The drain cleaner as set forth in claim 16 comprising:
a drive assembly for rotating the drum, the drive assembly comprising a motor disposed in the housing;
a switch that powers the drive assembly upon actuation of the switch by an operator, the drain cleaner being configured to power the light assembly during actuation of the switch and for a time period after the switch ceases to be actuated by the operator.
